(19) United States
(12) Patent Application Publication
(10) Pub. No.: US 2007/0073635 A1
(43) Pub. Date: Mar. 29, 2007

(54) Table rows filter

(75) Inventor: Peter Vignet, Palo Alto, CA (US)

Correspondence Address: HOLLAND & KNIGHT, LLP, 10 ST. JAMES AVENUE, BOSTON, MA, 02116, US

(73) Assignee: SAP AG, Walldorf (DE)

(21) Appl. No.: 11/237,146

(22) Filed: Sep. 28, 2005

(51) Int. Cl. G06F 17/30

(52) U.S. Cl. 707/1

(57) ABSTRACT

Methods and apparatus, including computer program products, for a table rows filter. A computer-implemented method of displaying information on a computer display device includes loading data into a table node data structure memory, the table node data structure including node elements and attributes, each of the node elements including a visibility attribute, and displaying a first view on the display device, the first view including a first subset of the data arranged in a table of rows and columns received from the table node data structure, the first subset data matching a first filtering criteria and a state of each of the visibility attributes. The method can include displaying a second view on the display device, the second view including a second subset of the plurality of data arranged in the table of rows and columns received from the node data structure, the second subset data matching a second filtering criteria and the state of the visibility attributes.

### BACKGROUND

The present invention relates to data processing by digital computer, and more particularly to a table rows filter.

SAP Web Dynpro is an integral part of a SAP Web Application from SAP AG that provides a design-time environment that is independent of the underlying runtime environment and enables companies to model and design UIs cost-effectively and precisely. A Web Dynpro application includes a set of views, navigation between the views, concepts for managing the views and determining their sequence, a context for keeping session data, and the business logic of the application.

Web Dynpro is built on a concept of a Model View Controller (MVC). The MVC paradigm allows for a strict separation of presentation logic, business logic, navigation, and eventing. MVC is the design pattern for efficiently relating a user interface to underlying data models. The MVC pattern is used in program development with programming languages such as Java, Smalltalk, C, and C++.

### SUMMARY

The present invention provides methods and apparatus, including computer program products, for a table rows filter.

In general, in one aspect, the invention features a computer-implemented method of displaying information on a computer display device, the method including loading data into a table node data structure memory, the table node data structure including node elements and attributes, each of the node elements including a visibility attribute, and displaying a first view on the display device, the first view including a first subset of the data arranged in a table of rows and columns received from the table node data structure, the first subset data matching a first filtering criteria and a state of each of the visibility attributes.

In embodiments, the method can include displaying a second view on the display device, the second view including a second subset of the data arranged in the table of rows and columns received from the node data structure, the second subset data matching a second filtering criteria and the state of the visibility attributes.

The visibility attribute can a Boolean value. A true Boolean value can signify a row is visibly displayed and a false Boolean value can signify a row is not visibly displayed.

The first and/or second views can include a summary of a number of visible rows and a number of non-visible rows and/or a summary of a total number of visible rows and non-visible rows.

Other features and advantages of the invention are apparent from the following description, and from the claims.

### BRIEF DESCRIPTION OF THE DRAWINGS

FIG. 1 is a block diagram of an exemplary system.

FIG. 2 is a block diagram of an exemplary table user interface (UI).

FIG. 3 is a flow diagram.

Like reference numbers and designations in the various drawings indicate like

### DETAILED DESCRIPTION

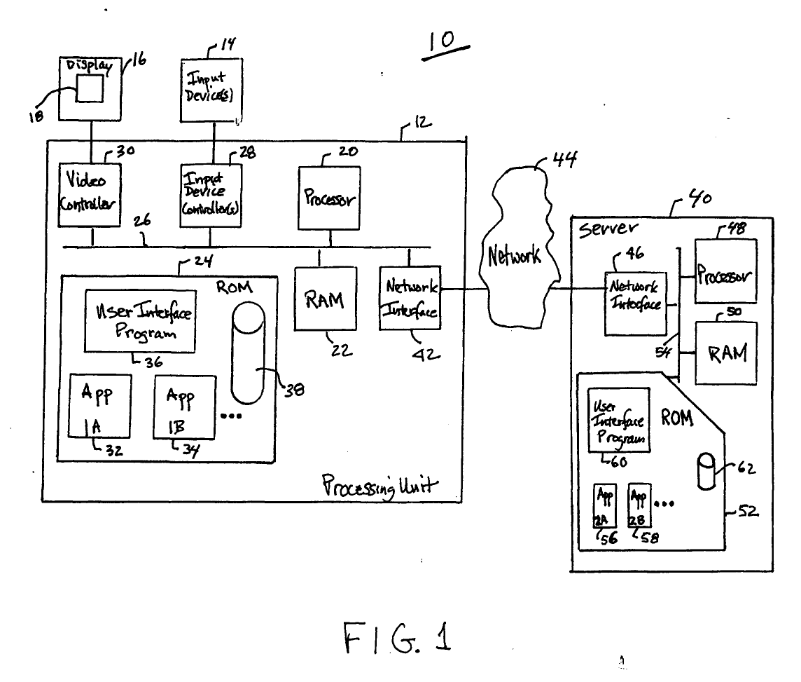

As shown in FIG. 1, an exemplary computer system 10 includes a processing unit 12, one or more input devices 14, and a display device 16, upon which a user is presented displays. The display device 16 has a video screen 18 upon which displays appear.

The processing unit 12 can include a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The system 10 is not limited to a personal computer (PC), but could include a personal digital assistant (PDA), a terminal, a workstation, or other such device.

ROM 24 provides non-volatile data storage for various application programs. In the example shown, a number of different application programs 32, 34, are stored in ROM 24. Also stored in ROM 24 is a user interface (UI) program 36 designed to work in concert with each of the application programs 32, 34. This is conceptually depicted by the UI program 36 shown as a layer on top of the application programs 32, 34. With such a design, UI program modules common to several application programs need not be duplicated in each of the application programs 32, 34. In addition, such a design may enable a common “look-and-feel” to the UI for the different program applications 32, 34. In other examples, the UI program, or module, is not a common program or module for more than one program application. In still other examples, the components described can be combined or separated in various manners, and can be stored in various manners, such as on various non-volatile storage medium.

Programs 32, 34, 36 have program instructions that can be loaded into RAM 22 during operation. Processor 20 then executes the program instructions, as required, to perform desired program functions.

Also stored in ROM 24 are various data in database 38. Database 38 includes data needed or generated during operation of the application programs 32, 34. Although only a single database 38 is shown that serves as a common database for all applications 32, 34, in other examples there can be separate databases for one, or more, of the applications 32, 34.

System 10 includes connection to a server 40 and a network interface 42, connected to its data bus 26. As such, system 10 can access server 40 over network 44 to run applications residing on the server 40. Network 44 can be, for example, a Local Area Network (LAN), Wide Area Network (WAN), or the Internet.

The server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, as well as a common user interface program 60 for the application programs 56, 58. ROM 52, in this example, includes data stored in database 62, although in other implementations separate databases or a separate database server may be required.

As an example, a table displayed on a UI is described using Web Dynpro from SAP AG. However, the methods described can be used in other U's generated by other application programs.

Version 4 of SAP's xRPM (Resource Planning Management) is called xPPM (Portfolio Planning Management) and uses SAP's Web Dynpro. As described above, Web Dynpro is an integral part of a SAP Web Application that provides a design-time environment that is independent of the underlying runtime environment and enables companies to model and design user interfaces (U's) cost-effectively and precisely.

Web Dynpro is built on the concept of MVC (Model View Controller). An abstraction of a Model View Controller (MVC) is a design pattern often used by applications that need an ability to maintain multiple views of the same data. The MVC pattern hinges on a clean separation of objects into one of three categories, i.e., models for maintaining data, views for displaying all or a portion of the data, and controllers for handling events that affect the model or view(s). Because of this separation, multiple views and controllers can interface with the same model. Even new types of views and controllers that never existed before can interface with a model without forcing a change in the model design.

Events typically cause a controller to change a model, or view, or both. Whenever the controller changes a model's data or properties, all dependent views are automatically updated. Similarly, whenever the controller changes a view, for example, by revealing areas that were previously hidden, the view gets data from the underlying model to refresh itself.

As described above, Web Dynpro is designed on the concept of a MVC. A Model is any layer of software code that encapsulates some business functionality external to a Web Dynpro component. The Model provides access to functionality such as Business Application Programming Interface (BAPI) calls or Web Services, and can be implemented, for example, as a set of proxy objects or Enterprise JavaBeans (EJB).

The Controller acts as a binding layer between the model and the view layers. The Controller has a Context. A Context is one hierarchical data storage structure for the controller. A Context includes hierarchical arrangements of entities known as nodes and attributes. A node can be a value node or model node. A value node holds the data itself, whereas a model node holds a reference to an external (model) object storing the data. A node is permitted to have children, an attribute is not. A node represents a collection. Each node has a collection of elements. Each element has a set of attributes. Each attribute element holds data. Nodes and Attributes can be created at design time or at run time.

A view includes a set of user interface (UI) elements than can both display application data and receive input. UI elements are bound to a Context that contains the data relevant in the View.

To represent tables for an end user, Web Dynpro uses UI Web Dynpro Tables. A UI Web Dynpro Table represents a two-dimensional data set arranged in rows and columns. A UI Web Dynpro Table represents data from the view context. A table receives its data from a multi-element context node stored in memory. At runtime, each element of the node is a table row. The number of table rows is identical to the number of node elements. The table columns correspond to the node attributes.

Filtering in a Web Dynpro table is a costly data manipulation process. SAP UI Dynpro Table does not provide filtering code, which developers are forced to design independently. To design a filtering function, two approaches can be taken. A first approach is to use a back end system call that does filtering. For every change in the filter, a new performance consuming call is required and the table node is repopulated with new elements.

A second approach involves a buffer context node. The buffer context node contains a complete collection of elements provided by the back end system. A filtering action copies from the buffer node to the table's node the elements that match the filter requirements. Every time a filter value changes, the table node has to have all its elements removed and then rebuilt from the buffer node according the filter values.

Both these approaches are laborious, cumbersome and performance costly processes.

The method described herein is a table rows visibility filter that includes storing all collections of elements in the table node permanently. Each of the elements includes an attribute property referred to as “visibility.” The visibility attribute enables a designer to make a node element a visible or a non-visible row in a table. Each time filter requirements are changed, the row filter class simply loops through each element and compares its attributes to the changed filter requirements. If an element matches the changed requirements the element, the visibility attribute is set “on” and the row in the table will be visible. If an element does not match the change requirements, the visibility attribute is set to “off” and the row in the table will not be visible.

To make a row table visible or non-visible, the element “visibility” is mapped to each column cell editors of the table. The visible elements are made the top elements of the node and consequently the visible rows are the first rows of the table. This can be implemented, for example, by a common DC or a set of filtering and sorting classes dynamically instantiated at run time in the context.

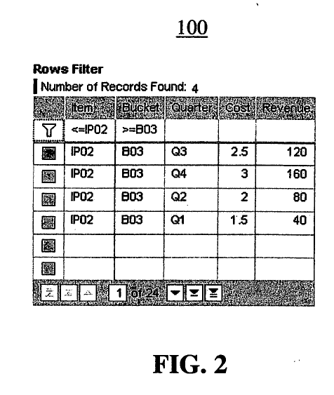

As shown in FIG. 2, an exemplary table UI 100 can include twenty-four rows of data. Here, UI table 100 displays four visible rows that match a particular filter requirement and twenty non-visible rows that do not meet the particular filter requirement. In this table UI 100 the four visible rows are displayed as the first four rows. In one example, the table UI can display the number of filtered (e.g., non-visible) rows.

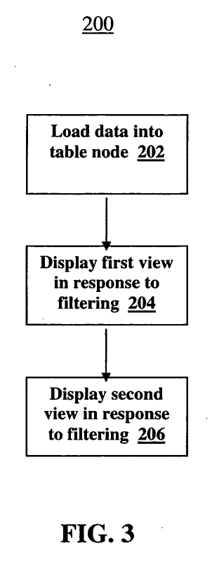

As shown in FIG. 3, a process 200 for displaying information on a computer display device includes loading (202) data into a table node data structure memory, the table node data structure including node elements and attributes, each of the node elements including a visibility attribute. Process 200 displays (204) a first view on the display device, the first view including a first subset of the data arranged in a table of rows and columns received from the table node data structure, the first subset data matching a first filtering criteria and a state of each of the visibility attributes. In response to a second filtering criteria, process 200 displays (206) a second view on the display device, the second view including a second subset of the data arranged in the table of rows and columns received from the node data structure, the second subset data matching a second filtering criteria and the state of the visibility attributes.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method of displaying information on a computer display device, the method comprising:
loading a plurality of data into a table node data structure memory, the table node data structure comprising a plurality of node elements and attributes, each of the node elements including a visibility attribute; and
displaying a first view on the display device, the first view comprising a first subset of the plurality of data arranged in a table of rows and columns received from the table node data structure, the first subset data matching a first filtering criteria and a state of each of the visibility attributes.

2. The computer-implemented method of claim 1 further comprising:
displaying a second view on the display device, the second view comprising a second subset of the plurality of data arranged in the table of rows and columns received from the node data structure, the second subset data matching a second filtering criteria and the state of the visibility attributes.

3. The computer-implemented method of claim 1 wherein the visibility attribute is a Boolean value.

4. The computer-implemented method of claim 3 wherein a true Boolean value signifies a row is visibly displayed.

5. The computer-implemented method of claim 3 wherein a false Boolean value signifies a row is not visibly displayed.

6. The computer-implemented method of claim 1 wherein the first view further comprises a summary of a number of visible rows and a number of non-visible rows.

7. The computer-implemented method of claim 6 wherein the first view further comprises a summary of a total number of visible rows and non-visible rows.

8. The computer-implemented method of claim 2 wherein the second view further comprises a summary of a number of visible rows and a number of non-visible rows.

9. The computer-implemented method of claim 8 wherein the second view further comprises a summary of a total number of visible rows and non-visible rows.

10. A computer program product, tangibly embodied in an information carrier, for displaying information on a computer display device, the computer program product being operable to cause data processing apparatus to:
load data into a table node data structure memory, the table node data structure comprising a plurality of node elements and attributes, each of the node elements including a visibility attribute; and
display a first view on the display device, the first view comprising a first subset of the plurality of data arranged in a table of rows and columns received from the table node data structure, the first subset data matching a first filtering criteria and a state of each of the visibility attributes.

11. The computer program product of claim 10 further causing data processing apparatus to:
display a second view on the display device, the second view comprising a second subset of the plurality of data arranged in the table of rows and columns received from the node data structure, the second subset data matching a second filtering criteria and the state of the visibility attributes.

12. The computer program product of claim 10 wherein the visibility attribute is a Boolean value.

13. The computer program product of claim 12 wherein a true Boolean value signifies a row is visibly displayed.

14. The computer program product of claim 12 wherein a false Boolean value signifies a row is not visibly displayed.

15. The computer program product of claim 10 wherein the first view further comprises a summary of a number of visible rows and a number of non-visible rows.

16. The computer program product of claim 15 wherein the first view further comprises a summary of a total number of visible rows and non-visible rows.

17. The computer program product of claim 11 wherein the second view further comprises a summary of a number of visible rows and a number of non-visible rows.

18. The computer program product of claim 17 wherein the second view further comprises a summary of a total number of visible rows and non-visible rows.
